(19) United States
(12) Patent Application Publication
(10) Pub. No.: US 2010/0026798 A1
(43) Pub. Date: Feb. 4, 2010

(54) Method and System for Capturing Physiological and Video Data and Subsequently Marking the Data While Viewing the Video

(76) Inventor: David J. Schmid, Richardson, TX (US)

Correspondence Address: CARR LLP, 670 FOUNDERS SQUARE, 900 JACKSON STREET, DALLAS, TX, 75202, US

(21) Appl. No.: 12/576,531

(22) Filed: Oct. 9, 2009

Related U.S. Application Data
(62) Division of application No. 11/078,596, filed on Mar. 11, 2005.

(51) Int. Cl. H04N 7/18

(52) U.S. Cl. 348/61; 348/E07.085

(57) ABSTRACT

A method and an apparatus are provided for capturing or collecting physiological, video and other experiment related data in digital format and storing the collected data. Each piece of data, including each individual video frame, is time stamped as received. The video is then reviewed offline, by a computer user, on a computer generated display presentation that includes a window of collected data indicia both before and subsequent to the time stamp of a given video frame being displayed. Different computer user defined marker types may also be displayed in the display window. Time stamped annotating marks may be made, by the computer user in response to user defined actions. The annotating marks may be displayed along with the collected data. Finally, the annotated marks, along with user selected portions of the collected data, may be saved for further review at a later time.

### CROSS-REFERENCE TO RELATED APPLICATIONS

This application is a division of, and claims the benefit of the filing date of, co-pending U.S. patent application Ser. No. 11/078,596 entitled METHOD AND SYSTEM FOR CAPTURING PHYSIOLOGICAL AND VIDEO DATA AND SUBSEQUENTLY MARKING THE DATA WHILE VIEWING THE VIDEO, filed Mar. 11, 2005. The entire contents of patent application Ser. No. 10/698,634, entitled: “INTER-FRAME VIDEO TECHNIQUES FOR BEHAVIORAL ANALYSIS OF LABORATORY ANIMALS” filed on 31 Oct. 2003, are incorporated herein by reference for all purposes.

### FIELD OF THE INVENTION

The present invention relates generally to the capture, displaying and annotating of physiological and digital camera data.

### DESCRIPTION OF THE RELATED ART

Neuroscience researchers implant laboratory animals with electrodes and record and time stamp physiological data to computer data files. One method of accomplishing the recording of this data is to use a device like the Multi-channel Acquisition Processor (MAP) sold by Plexon Inc of Dallas Tex. (the assignee of the present invention). In addition, researchers often like to simultaneously record the behavior of animals being studied using video cameras. An output of the MAP may be used to time stamp the visually displayable recording. Subsequent correlation of the video data with the physiological data is desirable and useful as it can reveal potential associations between overt animal behaviors and physiological data such as neuronal firing patterns.

One of the problems with the prior art process of correlation is that the video and physiological data are typically on different media and require different equipment to view the two sets of data. The correlation, mentioned above, is typically accomplished by having someone watch a display of the recorded video and noting, on paper or in some form of data base, the time stamp which occurs at the time of noted actions by the animal or other subject being studied. These sets of time stamped data are then processed in a computer to tie them with the relevant data in the physiological data file. There was no known way, in the prior art to obtain an interactive, simultaneous viewing of both the physiological and video data.

Another problem, in the prior art, is the limited precision of the time synchronization of physiological data with the video data.

One prior art attempt to overcome the synchronization problem is to record physiological data onto the audio track of a video camcorder. However, there is only enough room in the audio tracks to record two physiological data channels. Typically there are many more physiological data channels that are of interest in the subject being studied.

Known prior art systems for obtaining physiological data have collected either video view frame data or have obtained subject X and Y coordinate data. Often the collection of coordinate data is accomplished by attaching an LED (light emitting diode) to the subject being studied and, using color filtering and image processing techniques, ascertaining the X and Y coordinates of the LED light concentration within the video view frame. It should be noted, that it is sometimes difficult to discern subtle behaviors of a subject when only coordinate data is available. In animals, certain behaviors such as rearing up, freezing, feeding and so forth, may only be readily discernable by visually inspecting the video view frame data.

Known prior art systems for recording physiological data, that also monitor the physical actions of a subject, have either used retrieved coordinate data or visual video frames viewed by a user but not both.

It would be desirable to capture the video and the physiological data in an accurately time-synchronized manner along with biological entity position information also accurately time stamped. It would be further desirable to include time stamped audio, of the subject being studied, during the video capture time period. It would also be desirable to observe the video and physiological data of a subject on a single display as well as to edit and annotate the recorded data. Additionally, it would be desirable to be able to merge the original recorded physiological data and user generated markers and save the merged material to a file to facilitate later analysis.

### SUMMARY OF THE INVENTION

The present invention provides a method and a system for digitally capturing physiological data from a biological entity along with digital video frame data of the entity both of which are time stamped. The captured data is then processed offline and presented on a display. A first window display includes physiological data in the form of neuronal firing indicia over a selected time span while another window display presents a picture of the entity corresponding to a time near the center of the first display. A computer user can then generate markers to annotate the captured information based upon activity observed or entity position data collected from the video frame.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a prior art method of collecting both subject time stamped position data and time stamped physiological data;

FIG. 2 is a block diagram of equipment involved in physiological and video data capture;

FIG. 3 is a block diagram illustrating files generated and used in the data capture and markup;

FIG. 4 is a high level flow diagram of the process of time stamping retrieved video frames along with image processing to extract subject entity position information;

FIG. 5 is a high level flow diagram illustrating the steps involved in the physiological data markup process; and

FIG. 6 illustrates the information that may be displayed on the markup screen for facilitating the markup and annotation process.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combinations thereof. In a preferred embodiment, however, the functions are performed by a processor such as a computer or an electronic data processor in accordance with code such as computer program code, software, and/or electronic circuits that are coded to perform such functions, unless indicated otherwise.

The term “physiological data”, in this patent, is intended to cover data like neuronal firing, local field potentials, electroencephalocorticograms, electroencephalograms and so forth that may be monitored and/or analyzed by researchers. While a significant and major use of the present invention is the field of physiological data research, the present invention is useful in any situation where data collected online is later, offline, analyzed and marked or annotated whether or not in conjunction with video frame data. An example of such other use may be an analysis by the police of security monitoring videos after a crime.

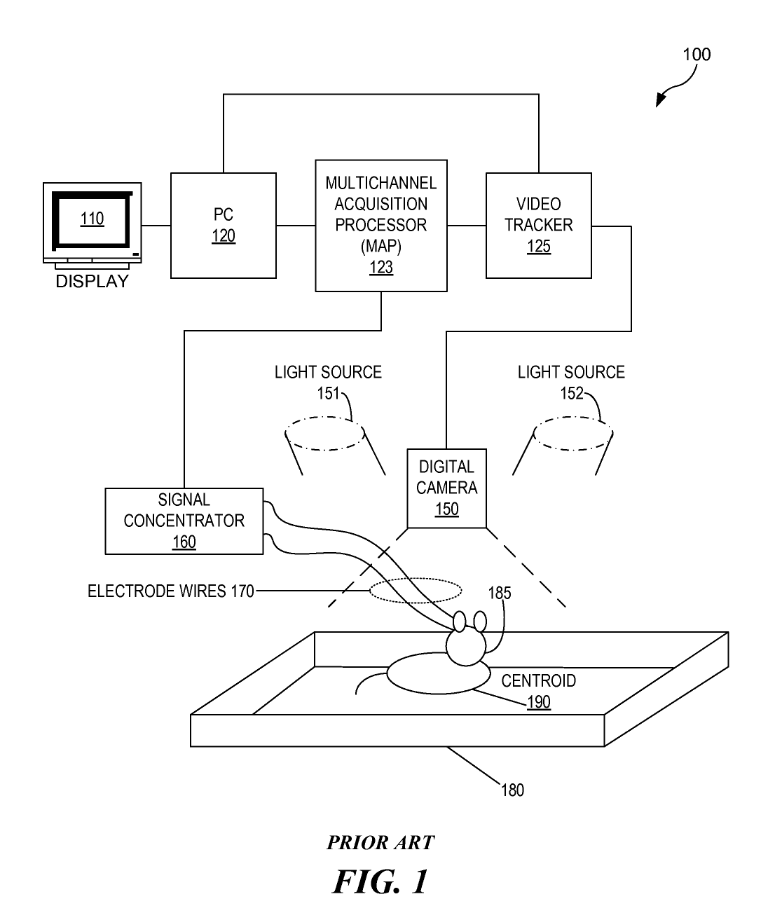

Referring to FIG. 1 of the drawings, illustrated is a prior art system 100 for measuring the change of a centroid position of a test animal from a first video frame to a second video frame. In the system 100, a test animal 185 is allowed to move within a receptacle 180. The system 100 tracks the change of a centroid 190 from video frame to video frame, and correlates these changes to measured brainwaves as a function of time. From these brainwave measurements and any centroid change in position, the correlation of brainwaves to behavior of the test animal can be deduced.

In the system 100, the test animal 185 is illuminated by two light sources 151 and 152. The brain and nervous system of the test animal 185 is coupled to a brainwave acquisition processor and concentrator 160 through electrode wires 170 or other suitable means. The concentrator conveys the measured brainwaves of the test animal 185 to the MAP 123. Within the MAP 123, the measured brainwaves are also time stamped.

The test animal 185 is also photographed at regular intervals, such as 30 times per second, by a camera 150. The resulting image (“video frame”) is sent to the video tracker 125. Within the video tracker 125, digital signal processing (DSP) is performed upon each picture element or “pixel” of the image. One of the DSP actions performed by the video tracker 125 is that of determining the centroid 190 of the test animal 185 for each video frame. This information is then conveyed to the MAP 123. The MAP 123 then time stamps the position of the centroid for each video frame. The MAP 123 then correlates the time stamp for the measured brainwaves to the time stamp for the centroid for each video frame. This correlation is then sent to a computing device 120, such as a personal computer (PC) for further analysis. Video frames, including their corresponding centroids, may be sent to the PC 120 for display.

The PC 120 acts as a server for a display 110. The PC 120 can also be used to filter and perform further digital signal processing upon the measured brainwaves time stamped by the MAP 123. The display 110 can show the calculated centroid position and the change of centroid from video frame to video frame. The display 110 can also show various brainwaves, both in the original form of graphed raw data and processed data. The processing of the brainwaves can be performed as a function of parameters input by a researcher.

It should be noted that display 110, in this prior art system, shows only an indication of the centroid of the subject 185 and does not show the subject or the receptacle 180 as such. In other words, from this display, no determination can be made if the entity is standing, sitting, eating, fighting or lying down.

Other prior art systems, similar to that of FIG. 1, used by physiological data researchers, have used analog cameras to take time stamped video pictures of the subject while taking the neural data. These video pictures were stored on tape for later review. As mentioned previously in the background section, the actions observed in the review process were then noted along with the time of occurrence for later correlation with subject's neural and other related data.

Another similar prior art approach for correlating the subject's actions with neural data has been to place LED (light emitting diodes) on the subject, take video pictures, color filter the data obtained and using appropriate software, obtain time stamped X and Y coordinates of each of the LED light sources as data to be reviewed in connection with the neural data. This system also had no visual display of the subject available for use in an offline review process.

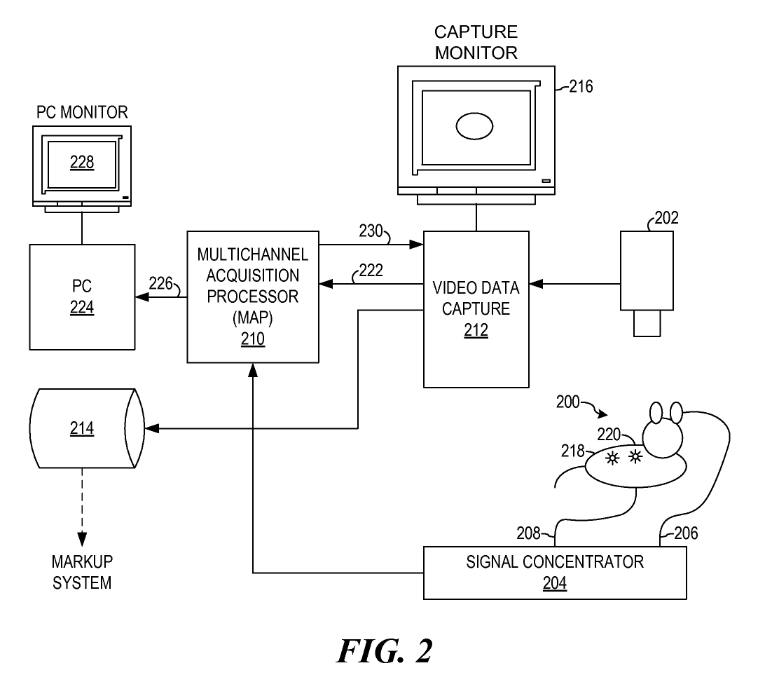

Referring now to FIG. 2, a subject biological entity 200 is shown in a position where a digital camera, such as a video camera 202 can capture all movements of the entity 200 within an enclosed environment (not specifically shown). A signal concentrator 204, is attached by wires to electrodes that are used to sense neuronal firings and other physiological events occurring in the subject entity 200. Two wires designated as 206 and 208 are intended as being representative of many such wires. The computer 206 may also receive inputs from audio and/or other signal generating devices (not shown) that may be collecting data relative to the experiment being conducted. The block 204 forwards the data collected to a multichannel acquisition processor (MAP) 210 in substantially the same manner as in the prior art including that of the referenced patent application whose teachings are incorporated herein. This data is time stamped in the MAP 210.

The output of the digital camera is supplied to a video data capture computer 212 where each video frame is time stamped and arranged in a data storage medium in the form of an xxx.avi file. For convenience in use, this data storage medium is shown as a removable hard disk in block 214 but may be any easily accessible data storage medium. A dash line output of block 214 is labeled “Markup System” since the frame data is used subsequently in the markup or annotation portion of this invention. The computer also shows an output of the camera 202 on a capture monitor 216. Although not previously mentioned, the subject entity 200 may have attached to it, light emitting diodes (LEDs) 218 and 220. Software in the computer 212 can perform image analysis to extract two dimensional X & Y coordinate data of these LEDs. The software can distinguish the different LEDs by color as mentioned in the background material above. This coordinate data generated in computer 212 is forwarded to the MAP block 210 via an input lead 222, where it is time stamped. The computer 212 may alternatively extract time stamped centroid data from the video frames as presented in the referenced patent application. This centroid data is also supplied to the MAP block 210 on line 222. The position data supplied on line 222 may be referred to in later descriptions as data contained in an xxx.dvt file.

The MAP block 210 collects all the incoming data and forwards same to a further computer 224 on a line 226. The incoming data to computer 224 is organized into an xxx.plx file for use by the markup system to be later described. The resulting collected data is also shown on a monitor 228.

A timing source is used to time stamp the data in block 210. It should be mentioned that the physiological data such as neuronal firings is time stamped using a much higher frequency clock than the video frame data. In a preferred embodiment of the invention, the neuronal data is time stamped with a 40 KHz (kilohertz) clock while the video frames are time stamped with a 1 KHz clock. This same timing data is passed from MAP 210 to capture computer 212 via a lead 230. The lead 230 also provides control information from the MAP block 210 to the capture computer 212.

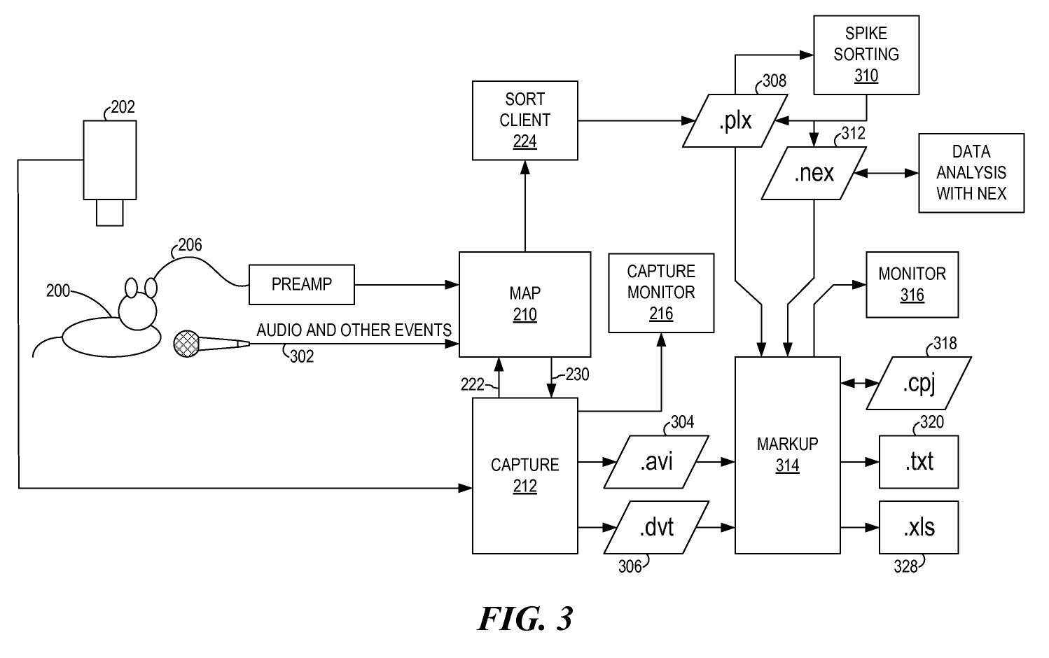

Referring now to FIG. 3 along with FIG. 2, the same designations are used for identical components used in FIG. 2. Although mentioned in connection with FIG. 2, audio and other non-neural data that may be collected was not specifically shown in FIG. 2. Such data collection is represented in FIG. 3 by the lead 302 supplying data to MAP 210. A video frame data file that is compiled by capture computer 212 and sent to data storage 214 is represented in this figure by a .avi block 304. An optional file containing the frame and coordinate timing information supplied by lead 222 is represented by a .dvt block 306. A physiological data file containing data supplied by MAP 210 on lead 226 to computer 224 and sorted by computer 224 is represented by a .plx block 308. The data in the .plx file block 308 may be further sorted by a spike sorting block 310 to produce a .nex file represented by a block 312. The standards for both the .plx file and the .nex file are well known in the prior art.

While the capturing of data is accomplished “online”, the review and markup and/or annotation of that data is accomplished later and “offline”. As shown, a markup computer block 314 receives the .avi file 304. It will also receive one of either the .plx file 308 or the .nex file 312 in accordance with the parameters of a specific experiment. The computer 314, in some situations, may also use data from the .dvt file 306. In the markup process, as will be explained further in connection with other figures, a computer user uses computer software in block 314 to generate marker types and then marks certain portions of data presented on a monitor 316 while observing any of position data, video frame presentations, neural data, audio data and so forth. The marker information, with or without the physiological data may be stored in a .cpj or project file as represented by a block 318. If stored as a .cpj file 318, it can be re-reviewed at a later time and additional marking types may be added. The marking data may also be output in various other formats. Two examples are provided in the drawing with a text file as represented by a block 320 or a spreadsheet file as represented by a block 322.

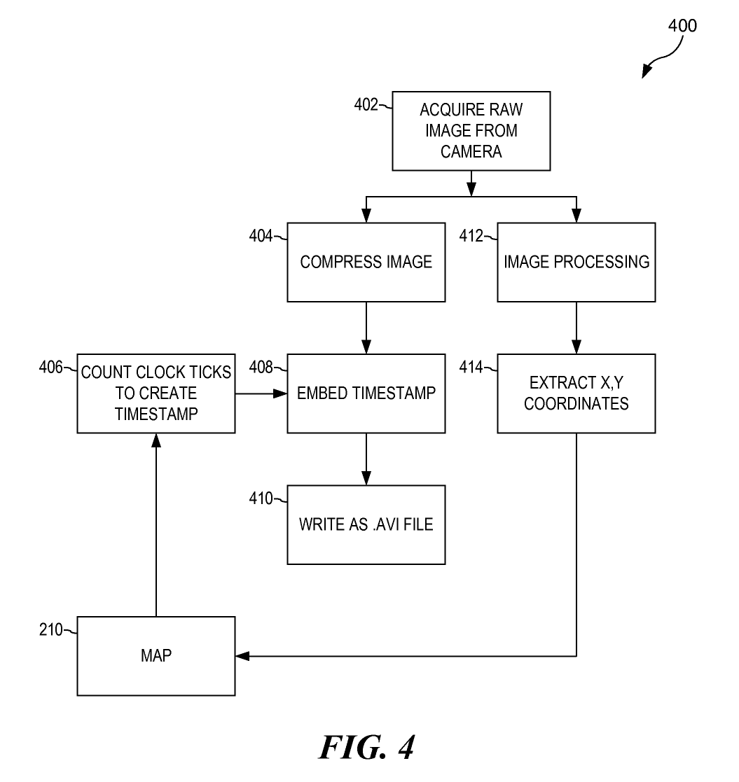

Referring now to FIG. 4, a block 402 represents the raw image data obtained from camera 202. In a step 404, this image is compressed to a desired level in the capture computer 212. In a preferred embodiment of this invention, it is stored in a motion-JPEG (Joint Photographic Experts Group) format. The ticks of a clock signal, obtained from the MAP device 210, are counted, as set forth in a block 406 to create time stamp information. This time stamp information is used, in a block 408, to embed timing information in the video image data before adding it to an avi (video data) file as shown in a block 410. The avi file is stored in a storage medium such as the hard drive 214 of FIG. 2. The capture computer 212 also, as set forth in blocks 412 and 414, processes the video data image to ascertain the coordinates of LEDs attached to the subject entity, of the centroid of the entity or some other distinct feature of the subject entity. This extracted position data is sent to the MAP device 210 as shown, where it is time stamped.

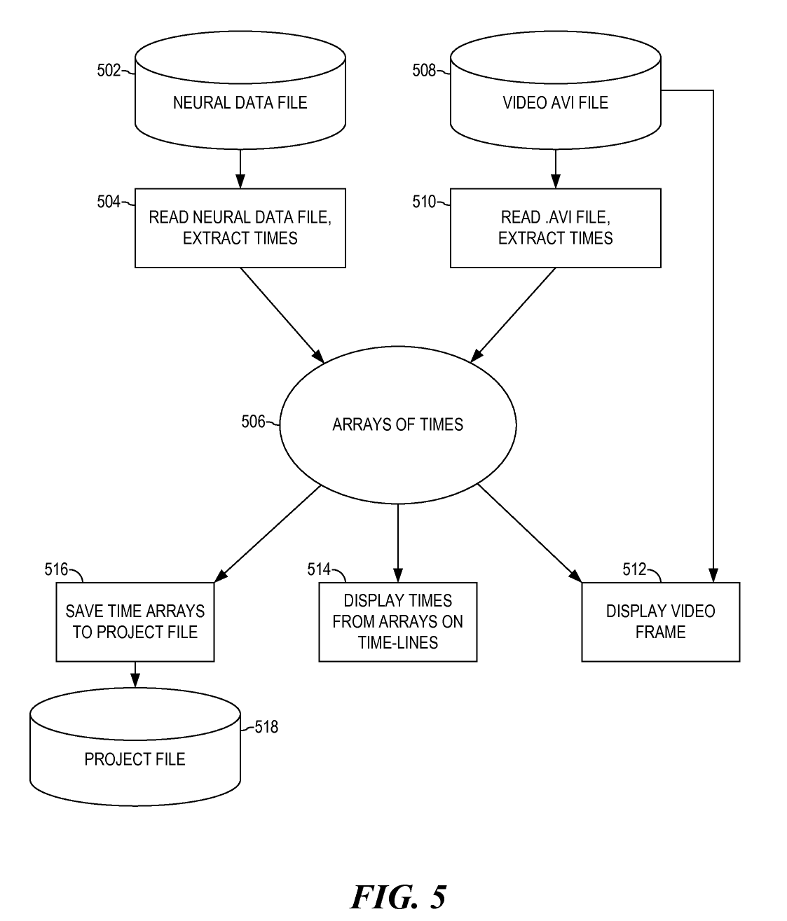

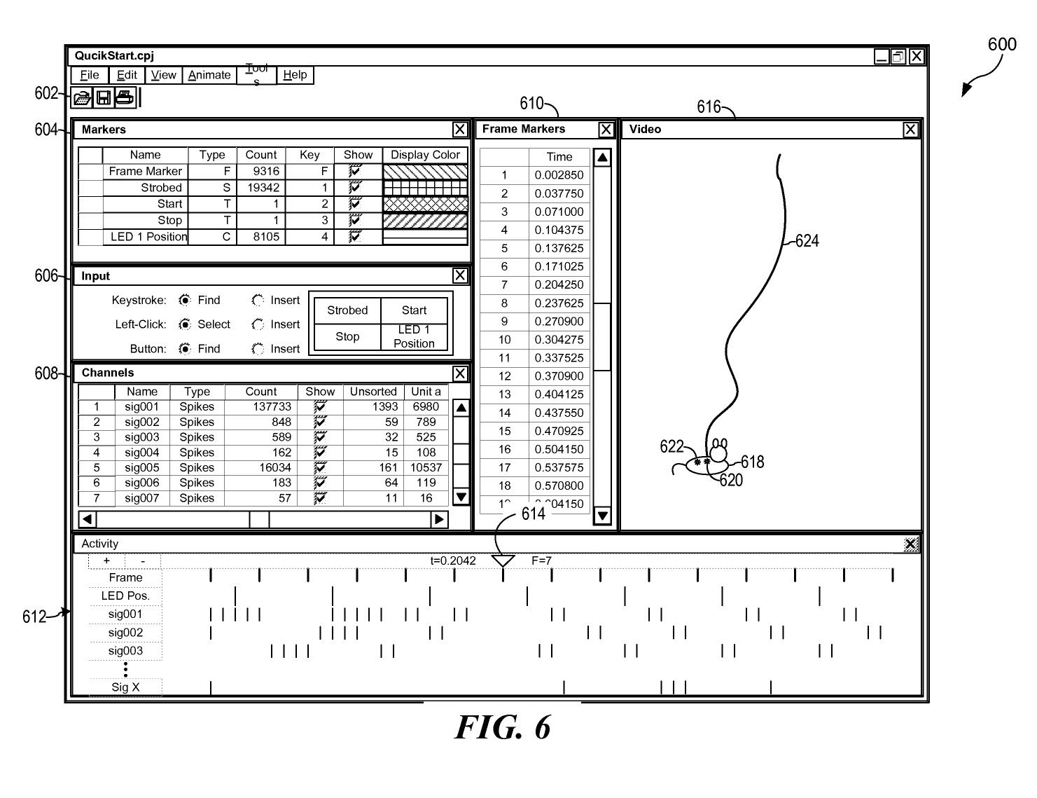

Referring to FIG. 5 in conjunction with FIGS. 2 and 3, it may be observed that a block 502 represents a neural data file such as the .plx or .nex files mentioned in connection with FIG. 3. The markup computer 314 reads the data and extracts the times, as set forth in a block 504. The data extracted is placed in a database array shown by a block 506. A block 508 represents a video or .avi file such as that contained in the data storage unit 214 or block 304. The marker computer 314 reads the .avi file, extracts the time stamps of each of the frames as set forth in a block 510 and also places this data in the time array 506. The video frames are displayed on the markup monitor 316 in time sequence as shown in a block 512. Markers, neural and other physiological data occurring during a time slot or range both before and after the time stamp of the video frame being displayed is also shown on marker monitor 316 as set forth in a block 514. The computer user can choose the amount and type of data to be displayed in an activity window of the markup monitor 316. Both the activity window and the video window are illustrated in FIG. 6. The time array information available to be displayed is typically saved in a project or .cpj file as shown in blocks 516 and 518.

Referring now to FIG. 6, in conjunction with FIG. 3, there is shown a display window generally designated as 600 that would appear on markup monitor 316. This overall or general window 600 can be altered by the markup user to comprise many windows or just a few windows of data. The system, in a preferred embodiment typically shows a default set of windows. Some of the often used default windows are shown to illustrate the types of data a markup computer user may consider or view in marking or otherwise annotating the physiological data or any other data being reviewed. There is shown in this figure a menu and toolbar portion 602 that may be configured to contain often used tools in a manner known in the typical computer window. A section 604 may comprise a list of markers that have been configured by the markup user for use with the data being reviewed. The markers window 604 may comprise columns of information such as the name assigned to the marker, the type of marker, the total number of marks or ticks of this type contained in the entire project file, whether or not this marker is to be displayed in the activity window, what color marker was chosen by the markup user to be displayed and so forth.

An input window, labeled 606, may be used to edit or alter the manner in which the insertion of new marker occurrences are inserted for selected markers. As an example, such occurrences may be inserted by a button selection, a mouse click, a keystroke and so forth.

A Channels window, labeled 608, may be used to display an entry for each data channel in the data file being displayed. Each channel may include information such as the name of the channel, the type of channel such as spike or continuous, the count of total number of spikes for a channel or the number of samples for continuous channels, whether or not the data for that channel is to be displayed in the activity window and so forth.

A frame markers occurrences window, labeled 610, provides a listing of the times of marker occurrences for a given marker. As shown, the times are for the video frame marker but can be user selected to provide information on other markers.

An Activity window, labeled 612, is shown with a section on the left comprising the names or titles of all the markers and data channels that are to be displayed in the right hand section of window 612 as determined by the display selection process used in connection with windows 604 and 608. As shown in the right hand portion of window 612, vertical lines or tick marks are shown indicating the time of occurrence of each piece of data for a given time window. As shown, a triangular marker 614, in the upper center of window 612, shows the position that corresponds to the time stamp of a video frame displayed in a window 616. The time slot shown may be user adjusted to be greater or lesser as can the position of the display with respect to the time stamp indication 614. The ticks after the title “Frame” illustrate each occurrence of a new video frame. As shown, the data, such as neuronal firings, for signal “sig 1” occurs quite often. On the other hand, the data for “sig X” occurs only once prior to the video frame designated by triangular marker 614.

A video window 616, provides a visual display of the subject being monitored and from which most of the data displayed in window 612 was derived. Within window 616, there is shown a subject entity 618 having LEDs 620 and 622 attached. A user initiated action, input to the markup computer 314, may be used to present a trailing display or history, labeled 624, of the past positions of LED 620 as shown.

The present invention thus provides a new and novel method and apparatus for capturing visual and position data of a biological entity simultaneously with physiological data. Further, there is provided a new and novel method and apparatus for viewing the data obtained from a subject entity both before and subsequent to a given video frame, for conveniently marking data of interest for later or further review and for saving all or any portions of the marked data to permanent data storage. Such an arrangement eliminates prior art tedious steps such as recording by handwritten or typed notes the times of occurrences of actions of interest in a subject being studied, entering those times into a computer and then obtaining a data file to study.

While the operation of the present invention has been described relative to physiological data, the apparatus may be used to analyze any subject related data that may be better analyzed in conjunction with visual and/or other data of the subject such as sound and so forth.

Although the various files, used in the capture and markup process, have been shown and listed using standardized file name endings, any other file name designations may be applied while practicing the illustrated process. Also, while the collected data is shown as being contained in separate files for convenience and ease of explanation of operation, all the captured or collected data may be stored in a single file for initial retrieval by the markup computer 314.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method of marking physiological data from a living subject related in time to a video frame display of said living subject, the method comprising:
displaying time sequenced video frames as retrieved from
a first digital data file;
displaying, from a second file, a time range of physiological data relating to at least one of a plurality of neuron firings indicia on both sides of the time occurrence of the video frame being displayed at that time;
generating a third file comprising at least one data array of a defined marker; and
inserting a time related mark in said at least one data array as a function of an user initiated action directed to said defined marker for each of at least one user initiated action(s).

2. A method of marking neuronal firings from a biological entity related in time to a video frame display of said entity, the method comprising:
displaying time sequenced video frames as retrieved from a set of time stamped digital frame data;
displaying, from a set of time stamped digital neuronal firing data, a time range of physiological data relating to at least one of a plurality of neuronal firings indicia on both sides of the time occurrence of the video frame being displayed at that time;
generating a marker file comprising at least one data array of a defined marker; and
inserting a time related mark in said at least one data array of said marker file as a function of an user initiated action directed to said defined marker for each of at least one user initiated action.

3. The method of claim 4, additionally comprising:
defining a neuron related marker as directed by a computer user.

4. Neuronal firing marking apparatus comprising:
computer apparatus for generating, online, digital view frames and neuronal firing data for a biological entity wherein both the physiological data and the individual view frame data are time stamped relative a common clock source;
computer apparatus for displaying, offline, a view frame of a sequence of view frames and a time range window of neuronal firing indicia occurring prior and subsequent to the time of said view frame; and
marking means for generating a file comprising an array of defined marker times corresponding generally to specific view frames wherein the marker times are generated as a function of a given action by a computer user.

5. Signal merging apparatus comprising:
computer apparatus for retrieving video and subject related electrical signal data;
computer apparatus for displaying simultaneously, a view frame of a sequence of view frames and a time range window of subject related electrical signal indicia occurring prior and subsequent to the time of said view frame;
computer apparatus for creating defined annotation marks as a function of a given action by a computer user in the time range window; and
computer apparatus for generating a merged file comprising an array of defined annotation marks corresponding generally to specific view frames, video data and subject related data.

6. A method of marking and merging signals, comprising:
retrieving video and subject related electrical signal data;
displaying simultaneously, a view frame of a sequence of view frames and a time range window of subject related electrical signal indicia occurring prior and subsequent to the time of said view frame;
creating defined annotation marks as a function of a given action by a computer user in the time range window; and
generating a merged file comprising an array of defined annotation marks corresponding generally to specific view frames, video data and subject related data.

7. A computer program product for marking and merging signals, the computer program product having a medium with a computer program embodied thereon, the computer program comprising:
computer code for retrieving video and subject related electrical signal data;
computer code for displaying simultaneously, a view frame of a sequence of view frames and a time range window of subject related electrical signal indicia occurring prior and subsequent to the time of said view frame;
computer code for creating defined annotation marks as a function of a given action by a computer user in the time range window; and
computer code for generating a merged file comprising an array of defined annotation marks corresponding generally to specific view frames, video data and subject related data.
